(19) United States
(12) Patent Application Publication
(10) Pub. No.: US 2008/0292239 A1
(43) Pub. Date: Nov. 27, 2008

(54) Adiabatic Waveguide Transitions

(75) Inventors: Barthelemy Fondeur, San Jose, CA (US); Edmond J. Murphy, West Hartford, CT (US); Robert J. Brainard, Sunnyvale, CA (US)

Correspondence Address: CHRISTOPHER F. REGAN;Allen Dyer Milbrath and Gilchrist PA, 255 S Orange Ave, Orlando, FL, 32801, US

(73) Assignee: JDS Uniphase Corporation, Milpitas, CA (US)

(21) Appl. No.: 12/126,176

(22) Filed: May 23, 2008

Related U.S. Application Data
(60) Provisional application No. 60/940,235, filed on May 25, 2007.

(51) Int. Cl. G02B 6/12

(52) U.S. Cl. 385/14

(57) ABSTRACT

The invention relates to waveguiding structures in planar lightwave circuit devices that include a transition region between a slab waveguide and channel waveguides to reduce optical coupling loss. In particular star couplers and arrayed waveguide gratings incorporating the transition region of the present invention demonstrate reduced insertion loss. By creating a transition region composed of transverse rows intersecting the output waveguide array, where the rows have equal dimensions and the effective refractive index is controlled by increasing the spacing width gradually from row to row, an adiabatic transition is created from slab waveguide to channel waveguide array. This structure provides low insertion loss within practical manufacturing tolerances. In addition, the present invention has found that by incorporating the transition region of the present invention into an AWG, the reduced insertion loss can be controlled as uniform insertion loss across the channels.

### CROSS-REFERENCE TO RELATED APPLICATIONS

The present invention claims priority from Provisional Patent Application No. 60/940,235 filed May 25, 2007, entitled “Adiabatic Waveguide Transitions”, by Fondeur et al., which is incorporated herein by reference for all purposes.

### TECHNICAL FIELD

The present invention relates to optical devices formed in planar lightwave circuits including a transition region between slab waveguide and channel waveguides for reduced optical loss. In particular, the present invention includes star coupler and arrayed waveguide grating (AWG) devices including reduced loss transition regions.

### BACKGROUND OF THE INVENTION

Optical communications networks currently rely on planar lightwave circuit (PLC) devices such as star couplers, branch power splitters, arrayed waveguide gratings (AWG) and variable optical attenuators (VOA) to control numerous wavelength multiplexed optical signals simultaneously through the network.

PLCs comprise optical waveguides deposited and patterned on a substrate. In one common technology, doped silica core and cladding layers are deposited and patterned on a silica or silicon substrate. Other substrates and waveguide technologies may also be used. A common structure in a PLC is a star coupler. A star coupler is an M×N power distributor. The AWG incorporates two star couplers in its structure. The star coupler has a first array of M channel waveguides coupled to a slab waveguide and N channel waveguides coupled to an opposite side of the slab waveguide. The slab waveguide is a light guided structure in which light is permitted to propagate as a wavefront confined to single mode only in one dimension, whereas the channel waveguides confine the light to single mode transmission in both dimensions perpendicular to the propagation direction. An abrupt transition from the slab waveguide into an array of channel waveguides causes optical loss due to reflection and scattering. This loss is measured as insertion loss and is undesirable. Variations in reflection and scattering across the array can cause variations in the insertion loss which is also undesirable.

One of the problems at the transition between the slab and the output array of channel waveguides is that the channel waveguides are not continuous across the transition. There are gaps between each waveguide. These gaps are responsible for the reflection and scattering of light which is not coupled into the waveguides.

One proposed solution to this problem is to provide a taper of the channel waveguides in the output array which gradually increases the width of the waveguides in the fanout region such that the wide ends of the waveguides completely fill the endface boundary of the slab waveguide. However, such a design is not compatible with processing and manufacturing technology because the gap between the waveguides becomes too small to be resolved as the tapering waveguides near the slab waveguide. There are limits in PLC technology both to the size of structure that can be resolved lithographically, and to the size of spacing that can be completely coated with cladding material. An incomplete cladding leaves voids and causes unacceptable loss. If processing tolerances are too small, the manufacturing yield is reduced and manufacture becomes impractical.

For a silica waveguide PLC designed for approximately 1550 nm wavelength, the waveguide structures have a thickness (height) of 5 microns. An aspect ratio of a waveguide structure of height to width of near 1 is ideal. If the width of the waveguiding structure is reduced this ratio is increased. A waveguide structure smaller than 5 microns in width in a 5 micron height chip becomes harder to control within process variability. A practical limit for lithographically deposited waveguiding structures for silica on silicon PLCs is a width of at least 3 microns. Silicon dioxide cladding is typically applied surrounding the waveguide structures. A minimum gap size for reliable cladding is 1 micron, or more preferably 1.5 microns. These are only examples for silica PLCs for 1550 nm applications. Different materials and index contrast in alternative waveguide technologies, of course, will require different dimension limits.

The abrupt transition referred to above is the combination of a physical and an optical effect. The edges of the waveguides represent an abrupt change in the optical index. However, the optical field of the propagating wave is not entirely confined to the core of the waveguide. Rather, it extends into the cladding area that surrounds the core. So, the effective optical index that determines the propagation of the optical field is determined by the combined effect of the index in the core and the index in the cladding. If one can change the effective (average) index of the waveguide, one can effect the optical mode size, mode propagation, insertion loss and insertion loss uniformity.

The present invention eliminates these abrupt transitions by introducing changes or perturbations to the cladding in such a way that the effective index controlling the propagating wave changes smoothly and monotonically from the slab guide to the output waveguides. Such gradual transitions have been investigated in the prior art. However, a solution that provides low insertion loss and insertion loss uniformity in a design that is compatible with high yield manufacturing processes is still needed.

The technique of gradually changing the effective refractive index is presented in an article by Weissman et al., “Analysis of Periodically Segmented Waveguide Mode Expanders” published in IEEE Journal of Lightwave Technology, vol 13, no. 10, October 1995. The article presents a periodically segmented waveguide structure for creating mode expanders for coupling from small mode size waveguides of Ti, InP or high index silica into much larger mode size silica fiber. The effective refractive index is determined by the duty cycle of the segmented waveguide. Only single mode waveguide coupling is considered.

U.S. Pat. No. 5,745,618 by Yuan P. Li assigned to Lucent Technologies Inc. proposes a segmented transition region between a slab waveguide and an output array of channel waveguides in a star coupler. Li discloses a plurality of parallel silica paths transversely intersecting the output waveguide array. In its optimum design including 30 transverse silica paths, the transition region is shown to have a significant effect reducing the insertion loss. Essential to this improvement is the design featuring silica paths having progressively smaller widths with increased distance from the slab.

However, as recognized in U.S. Pat. No. 7,006,729 by Yan Wang and Yuan P. Li assigned to Wavesplitter Technologies Inc., the prior art Li design is difficult to manufacture. The very small gaps between the silica paths and waveguides must be completely filled with cladding material. This requirement can be difficult to fulfill without the formation of voids in the spaced regions. This problem reduces the yield and increases the manufacturing cost.

As an alternative, Wang and Li propose a transition region within the slab. A series of transverse silica paths parallel to the edge of the slab have decreasing width and increasing spacing. A final silica path is integral with the output waveguide array. The design is simpler from a manufacturing perspective, however the segmentation in the slab region is expected to cause an insertion loss penalty greater than if the silica paths are included in the output waveguide region.

Another U.S. Pat. No. 6,892,004 by Guomin Yu discloses an alternative design for a transition region between slab and waveguide array. Yu also attempts to provide a design which can reduce insertion loss with a higher manufacturing yield. Yu suggests that gaps of at least 3.3 microns are required for a suitable production yield. Yu discloses a first transition region comprising transverse rows of silica separated by rows of cladding. Integrated into the silica rows are protrusions arranged as segmented waveguides aligned with the output array. The second transition section comprises continued segmented waveguides with no transverse rows of silica. Variables in the width of silica rows and spacing and in the lengths of waveguide segments and spacing allow for optimization of the gradual increase in refractive index contrast. However, the small features of the protrusions and segments make this more difficult to manufacture efficiently.

Although the problem of loss at the transition from slab waveguide to channel waveguides is recognized, an effective solution within available manufacturing tolerances is still needed. A star coupler which can be produced with a high production yield and can offer a low insertion loss is therefore desirable.

It is an object of the present invention to provide optical devices formed in planar lightwave circuits including a transition region between slab waveguide and channel waveguides for reduced optical loss within less stringent manufacturing tolerances.

A further object of the present invention is to provide star coupler and arrayed waveguide grating (AWG) devices including reduced loss transition regions.

A further object of the present invention is to provide an AWG including transition regions between slab waveguides and channel waveguides which enables insertion loss uniformity across the multiple channel spectrum.

### SUMMARY OF THE INVENTION

The present invention has found that by creating a transition region composed of transverse rows intersecting the output waveguide array, where the rows have equal dimensions and the effective refractive index is controlled by increasing the spacing width gradually from row to row, an adiabatic transition is created from slab waveguide to channel waveguide array. This structure provides low insertion loss within practical manufacturing tolerances. In addition, the present invention has found that by incorporating the transition region of the present invention into an AWG, the reduced insertion loss can be controlled as uniform insertion loss across the channels.

Accordingly, the present invention relates to An optical waveguide device comprising:

a slab region having a transition boundary;

an array of waveguides optically coupled to the slab region at the transition boundary; and

a transition region for reducing optical loss in the optical coupling between the slab region and the waveguide array comprising:

a plurality of transverse rows of waveguiding material substantially parallel to the transition boundary and intersecting the array of waveguides, each of the transverse rows having a substantially equal width and having a separation width from the previous transverse row, wherein the separation width has an increasing value for each subsequent transverse row with increasing distance from the transition boundary,

and wherein the transition region provides a gradual change in an effective refractive index from the slab region to the array of waveguides.

Another aspect of the present invention relates to an optical waveguide device comprising:

a slab region having an index boundary and a transition boundary opposite the index boundary;

at least one waveguide optically coupled to the slab region at the index boundary;

an array of waveguides optically coupled to the slab region at the transition boundary; and

a transition region for reducing optical loss in the optical coupling between the slab region and the waveguide array comprising:

a plurality of transverse rows of waveguiding material substantially parallel to the transition boundary and intersecting the array of waveguides, each of the transverse rows having a substantially equal width and having a separation width from the previous transverse row, wherein the separation width has an increasing value for each subsequent transverse row with increasing distance from the transition boundary,

and wherein the transition region provides a gradual change in an effective refractive index from the slab region to the array of waveguides.

In this embodiment the present invention comprises a star coupler in which light coupled into the at least one waveguide is transmitted through the slab region and is distributed among the array of waveguides coupled to the transition boundary in a first direction, and light coupled into the array of waveguides is transmitted through the slab region and combined into the at least one waveguide in a second, opposite direction.

Another feature of the present invention provides an optical waveguide device comprising:

a first slab region having an index boundary and a transition boundary opposite the index boundary;

a second slab region having an index boundary and a transition boundary opposite the index boundary;

a waveguide grating array optically coupling the first slab region to the second slab region through a first transition region at the transition boundary of the first slab region and through a second transition region at the transition boundary of the second slab region, wherein each waveguide in the waveguide grating array has a different optical length;

at least one waveguide coupled to the index boundary of the first slab region, and

a plurality of waveguides coupled to the index boundary of the second slab region, wherein the first and second transition regions each comprise:

a plurality of transverse rows of waveguiding material substantially parallel to the transition boundary and intersecting the waveguides of the waveguide grating array, each of the transverse rows having a substantially equal width and having a separation width from the previous transverse row, wherein the separation width has an increasing value for each subsequent transverse row with increasing distance from the transition boundary.

In this embodiment the device comprises an arrayed waveguide grating (AWG) for multiplexing and demultiplexing a plurality of signals of different wavelengths.

### BRIEF DESCRIPTION OF THE DRAWINGS

The invention will be described in greater detail with reference to the accompanying drawings which represent preferred embodiments thereof, wherein:

FIG. 1 is a schematic illustration of a star coupler having a transition region in accordance with the prior art;

FIG. 2 is a schematic illustration of an alternative star coupler having a transition region in accordance with the prior art;

FIG. 3 is a detailed enlargement of a transition region in accordance with the present invention having transverse rows of uniform width disposed at increasing spacing width with increased distance from the slab;

FIG. 4 is a detailed enlargement of a prior art slab to output waveguide interface without index moderating structures;

FIG. 5 is a schematic illustration of an arrayed waveguide grating (AWG) having two star couplers with transition regions between the star couplers and the waveguide grating;

FIGS. 6 A and B are graphic illustrations of insertion loss measurements for AWGs incorporating the transition regions of FIGS. 3, and 4; and

FIG. 7 is a schematic illustration of a star coupler 700 in accordance with the present invention.

### DETAILED DESCRIPTION

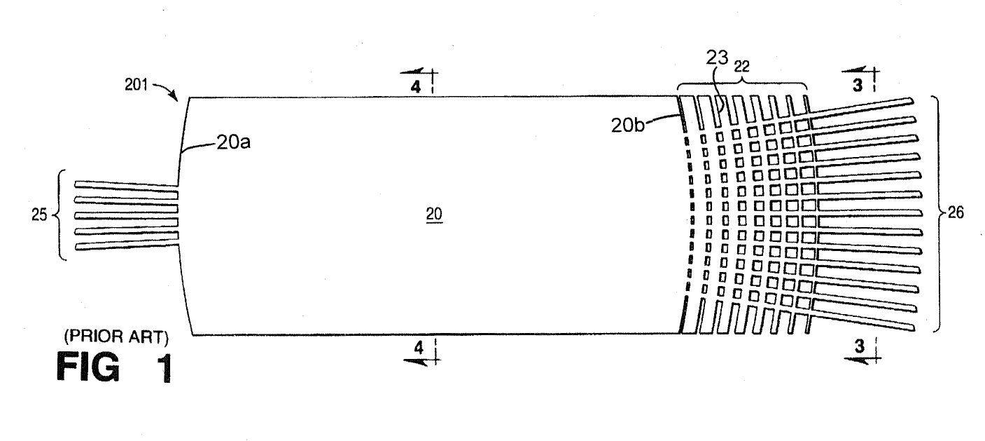

With reference to FIG. 1, a prior art star coupler 201 disclosed in U.S. Pat. No. 5,745,618 is shown having a transition region 22 comprising a plurality of paths 23 of silicon material which are generally parallel to each other and which transversely intersect the output waveguides 26 to significantly reduce insertion loss. Star couplers split the optical power entering any of its input ports among all of its output ports. Star coupler 201 includes a free-space region which comprises an optical slab waveguide 20 having two curved, preferably circular, boundaries 20a and 20b. Power transfer between an input waveguide array 25 and an output waveguide array 26 is accomplished through radiation in the slab 20. These waveguide arrays 25, 26 are radially directed toward virtual focal points and configured so that their respective foci are located a predetermined distance away from and outside the slab 20 to minimized phase errors caused by mutual coupling between adjacent waveguides. Each of these waveguide arrays is coupled to the slab 20 in a substantially uniform fashion along boundaries 20a and 20b. The loss of power due to the scattering of light at the junction between the array 26 and the slab 20, referred to as insertion loss, is reduced by the transition region 22.

However, this prior art star coupler 201 is difficult to manufacture because the many small areas adjacent to the intersections between the output waveguides 26 and the silica paths 23 must be completely filled with cladding material. Because of their small size this is difficult to accomplish without the formation of voids. In addition, the silica paths 23 decrease in width progressively with increasing distance from the slab. The small feature size also limits manufacturing tolerances, reducing yield and increasing the unit cost.

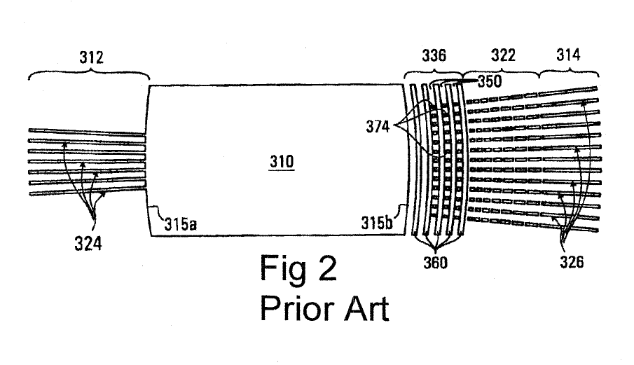

FIG. 2 shows an alternate transition region structure 336 in a prior art star coupler 310 disclosed in U.S. Pat. No. 6,892,004. In this embodiment a series of transverse segments 360 are spaced apart with core segments 374 of the output waveguide between them. The transverse segments 360 are not in contact with the core segments 374. Beyond the transverse segments 360, the output waveguides 326 are segmented for a second transition region before becoming continuous channel waveguides. This design also relies on cladding very small gaps between features.

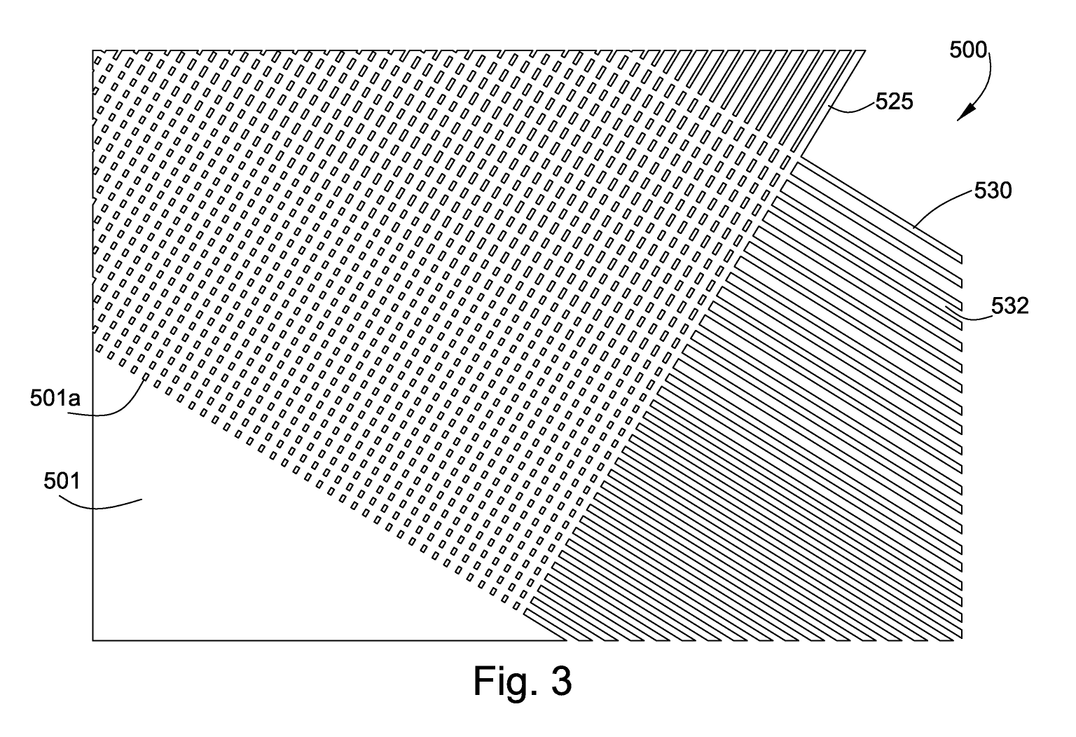

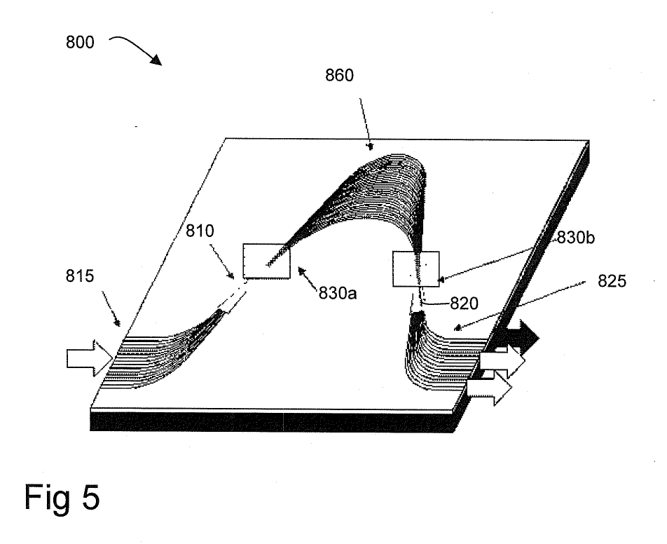

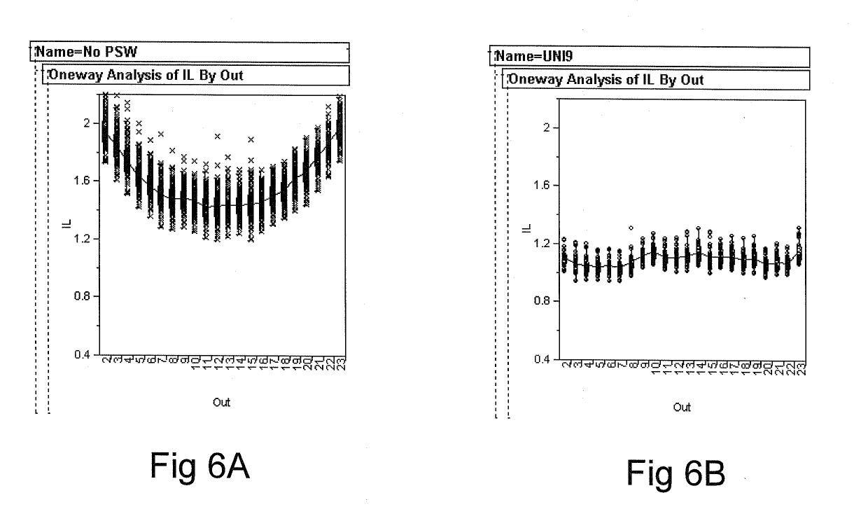

FIG. 3 is a detailed enlargement of a transition region 500 in accordance with the present invention. The slab 501 is coupled to the output array of channel waveguides 525 at an output boundary 501a. The waveguides 525 are spaced apart at the transition boundary 501a in accordance with process tolerances. Transverse rows 530 of core index material, such as silica deposited simultaneously with the slab and channel waveguides, are formed having equal width disposed at gradually increasing separation width 532. The transverse rows 530 are substantially parallel to the slab transition boundary and intersect the output waveguides 525. The increase in separation width 532 is generally monotonic. A variable in the design process is the spacing, with linear or quadratic, or other delta functions being available to modify the insertion loss profile. The width of the transverse rows 530 is also selected to control the shape of the insertion loss profile across the channels. Empirical experimentation of the row width and spacing profile led to a uniform insertion loss profile shown in FIG. 6B. The transverse rows have a constant width, selected from a range of approximately 5-20 microns. For the AWG of FIG. 5 in silica having an index contrast of 0.8% (percent), with the loss results measured in FIG. 6B, the transverse rows 530 have a preferred width of 9 microns. This width gives the uniform insertion loss across the channels for a center wavelength of 1550 nm. Transverse rows 530 may number 10 to 60 depending on the PLC structure, index contrast and material. The optimum for the transition regions of the AWG of FIG. 5, with the parameters given above, is 40 rows. The separation width 532 might be as large as 100 microns at the farthest from the slab transition boundary 501a in a 1550 nm device, but above this greater spacing will contribute excess loss. A waveguide device with a higher index contrast, such as indium phosphide with an index contrast of 2% will require more rows, approximately 50-60. A simplest manufacture is to deposit all waveguiding structures simultaneously, e.g., channel waveguides, slabs and transverse rows, all having a same index of refraction. It is also possible to moderate the index contrast through the transition region by depositing different index materials.

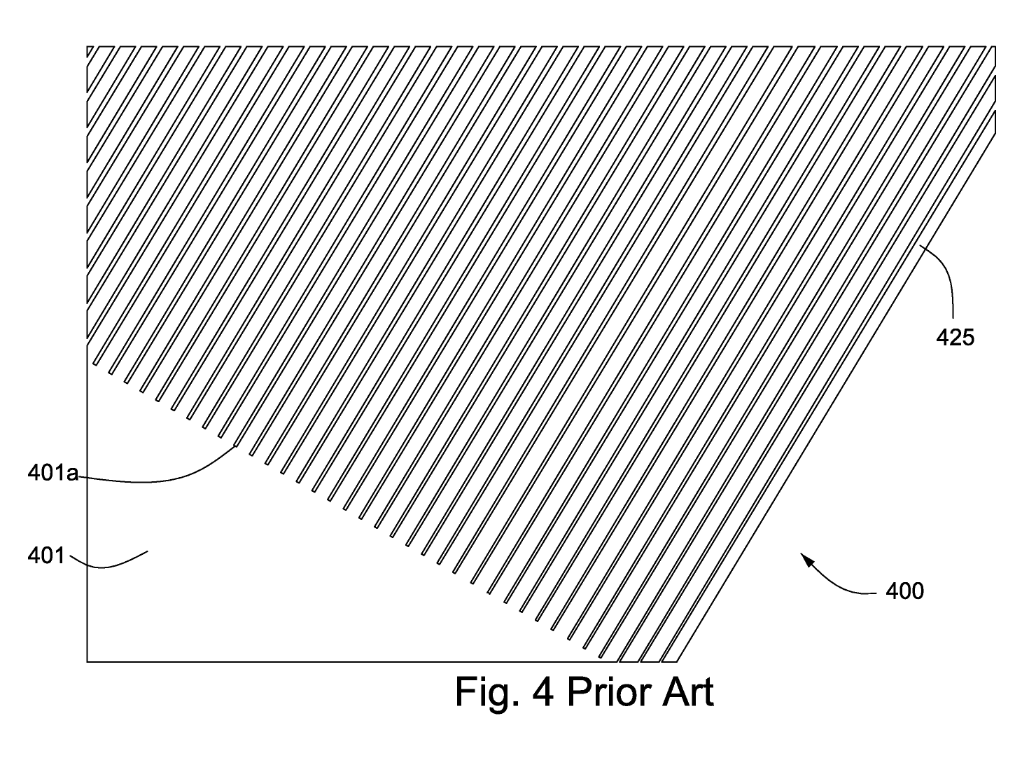

For comparison, FIG. 4 is a detailed view of the boundary 401a of slab 401 in a prior art star coupler 400. Insertion loss data for this structure in the star couplers of an AWG is shown in FIG. 6A.

FIG. 5 is a schematic illustration of an arrayed waveguide grating 800 in accordance with the present invention. The AWG comprises a multiplexing/demultiplexing router. It will be described in its demultiplexing function, although it is well understood that the device works equally in reverse direction as a multiplexer. Light input into input waveguides 815 having a plurality of wavelengths, e.g., 40, is coupled into the star coupler 810 through index boundary 811. Star coupler 810 has a transition region 830a of uniform transverse rows disposed at increasing spacing width with distance from the slab 810. The transverse rows intersect the waveguide grating array 860. Light from the transition region 830a is coupled into the waveguide grating 860. Light transmitted through the waveguide grating 860 is coupled through transition region 830b into the second star coupler 820. The phase differences imparted by the waveguide grating 860 cause the plurality of wavelengths to focus at locations on the index boundary 821 spaced apart by wavelength. The separated wavelength signals, e.g., 40 channels, are coupled into the output waveguides 825.

Comparison tests of the transition regions of FIGS. 3, and 4 in an AWG as shown in FIG. 5 measured the insertion loss across the channels. FIG. 6A shows the insertion loss profile for the prior art AWG with no index moderating transition structure as shown in FIG. 4. FIG. 6B shows an AWG having the transition regions of FIG. 3 demonstrating a significant decrease in insertion loss across all the channels. A further surprising result demonstrated is that the loss is flat or substantially constant across all the channels. This is particularly important for maintaining the integrity of multiplexed wavelength signals.

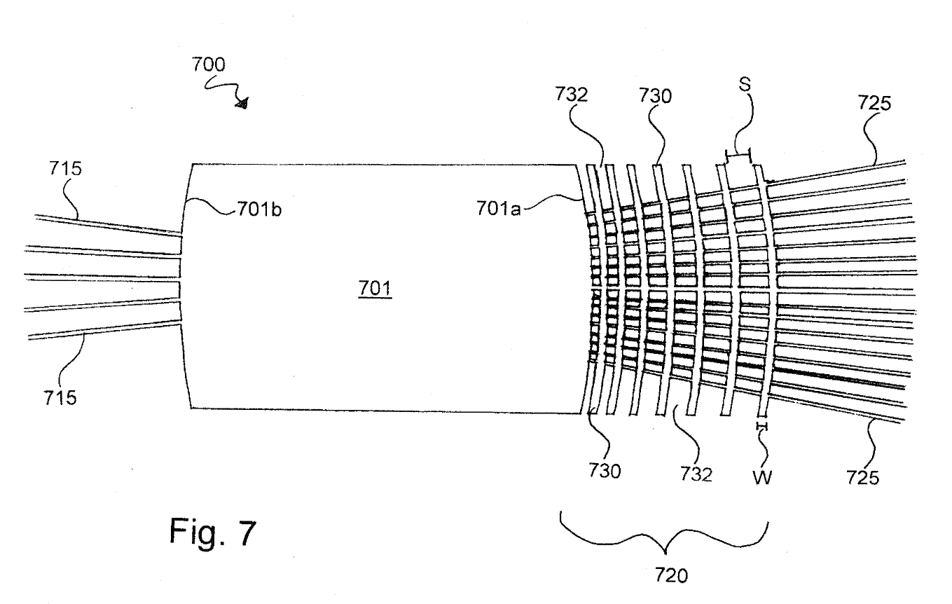

FIG. 7 is a schematic illustration of a star coupler 700 in accordance with the present invention. Input waveguides 715 transmit light into the slab region 701 through index boundary 701b. Light from the one or more input waveguides 715 is distributed from the slab waveguide 701 into the output waveguides 725 of the output waveguide array. Optical coupling from the slab region 701 across transition boundary 701a and into the channel waveguides 725 is improved by the index moderating structure of the transition region 720. The transition region 720 includes a plurality of transverse rows 730 of waveguiding material. Each row 730 has a substantially equal width W. The rows 730 are separated by a separation width 732 having a monotonically increasing separation width S. Separation width 732 increases with distance from the transition boundary 701a. The effect of the increasing separation width 732 in the transition region 720 is a gradual change in the effective refractive index from the slab region 701 to the array of output waveguides 725.

Numerous modifications and variations of the present invention are possible in view of the foregoing teaching. It is to be understood that within the scope of the following claims, the invention may be practiced otherwise than as specifically described herein.

We claim:

1. An optical waveguide device comprising:
a slab region having a transition boundary;
an array of waveguides optically coupled to the slab region at the transition boundary; and
a transition region for reducing optical loss in the optical coupling between the slab region and the waveguide array comprising:
a plurality of transverse rows of waveguiding material substantially parallel to the transition boundary and intersecting the array of waveguides, each of the transverse rows having a substantially equal width and having a separation width from the previous transverse row, wherein the separation width has an increasing value for each subsequent transverse row with increasing distance from the transition boundary,
and wherein the transition region provides a gradual change in an effective refractive index from the slab region to the array of waveguides.

2. An optical waveguide device as defined in claim 1, wherein the slab region, waveguides and transverse rows have a same index of refraction.

3. An optical waveguide device comprising:
a slab region having an index boundary and a transition boundary opposite the index boundary;
at least one waveguide optically coupled to the slab region at the index boundary;
an array of waveguides optically coupled to the slab region at the transition boundary; and
a transition region for reducing optical loss in the optical coupling between the slab region and the waveguide array comprising:
a plurality of transverse rows of waveguiding material substantially parallel to the transition boundary and intersecting the array of waveguides, each of the transverse rows having a substantially equal width and having a separation width from the previous transverse row, wherein the separation width has an increasing value for each subsequent transverse row with increasing distance from the transition boundary,
and wherein the transition region provides a gradual change in an effective refractive index from the slab region to the array of waveguides.

4. An optical waveguide device as defined in claim 3, wherein the waveguide device comprises a star coupler in which light coupled into the at least one waveguide is transmitted through the slab region and is distributed among the array of waveguides coupled to the transition boundary in a first direction, and light coupled into the array of waveguides is transmitted through the slab region and combined into the at least one waveguide in a second, opposite direction.

5. An optical waveguide device as defined in claim 4, wherein the index boundary and the transition boundary of the slab region are substantially circular arcs.

6. An optical waveguide device as defined in claim 4, wherein the slab region, waveguides and transverse rows all have the same index of refraction.

7. An optical waveguide device comprising:
a first slab region having an index boundary and a transition boundary opposite the index boundary;
a second slab region having an index boundary and a transition boundary opposite the index boundary;
a waveguide grating array optically coupling the first slab region to the second slab region through a first transition region at the transition boundary of the first slab region and through a second transition region at the transition boundary of the second slab region, wherein each waveguide in the waveguide grating array has a different optical length;
at least one waveguide coupled to the index boundary of the first slab region, and
a plurality of waveguides coupled to the index boundary of the second slab region, wherein the first and second transition regions each comprise:
a plurality of transverse rows of waveguiding material substantially parallel to the transition boundary and intersecting the waveguides of the waveguide grating array, each of the transverse rows having a substantially equal width and having a separation width from the previous transverse row, wherein the separation width has an increasing value for each subsequent transverse row with increasing distance from the transition boundary.

8. An optical waveguide device as defined in claim 7 wherein the device comprises an arrayed waveguide grating (AWG) for multiplexing and demultiplexing a plurality of signals of different wavelengths.

9. An optical waveguide device as defined in claim 7, wherein the substantially equal width of the transverse rows is a dimension selected to provide a substantially uniform insertion loss across the plurality of signals of different wavelengths.

10. An optical waveguide device as defined in claim 9, wherein the substantially equal width is selected from the range of 5-20 microns.

11. An optical waveguide device as defined in claim 10, wherein the plurality of transverse rows number in the range of 10-60.

12. An optical waveguide device as defined in claim 9, wherein the waveguide device is formed in silica having a 0.8% (percent) index contrast, and wherein the width of the transverse rows is 9 microns, and the number of transverse rows is 40.
